(19) United States
(12) Patent Application Publication
(10) Pub. No.: US 2025/0016019 A1
(43) Pub. Date: Jan. 9, 2025

(54) METHOD FOR PREDICTING OPERATIONAL ERROR OF HOME APPLIANCE AND SERVER PERFORMING THE SAME

(71) Applicant: LG ELECTRONICS INC., Seoul (KR)

(72) Inventors: Chiwan PARK, Seoul (KR); Hoonsang YUN, Seoul (KR); Daegeun SEO, Seoul (KR); Min Jung KANG, Seoul (KR)

(21) Appl. No.: 18/715,549

(22) PCT Filed: Mar. 25, 2022
(86) PCT No.: PCT/KR2022/004243

§ 371 Date: May 31, 2024

(30) Foreign Application Priority Data
Dec. 1, 2021 (KR) 10-2021-0169888

(51) Int. Cl. H04L 12/28; D06F 33/47; D06F 34/05; D06F 34/24; D06F 34/26; D06F 58/50; F24F 11/52; F24F 11/63; D06F 103/16; D06F 103/32; F24F 110/12; F24F 110/64; F24F 140/00

(52) U.S. Cl. CPC H04L 12/2809; D06F 33/47; D06F 34/05; D06F 34/24; D06F 34/26; D06F 58/50; F24F 11/52; F24F 11/63; D06F 2103/16; D06F 2103/32; F24F 2110/12; F24F 2110/64; F24F 2140/00

(57) ABSTRACT

A server for managing a home appliance and a method for controlling the same are disclosed. The disclosed server and control method therefor can obtain current information on a specific administrative division regarding a residential space, and compare the acquired current weather information on the specific administrative division with environmental information detected in a home appliance so as to predict in advance an operational error of the home appliance. Accordingly, it is possible to accurately predict an operational error of the home appliance that may occur in the further, and to prevent an operational error in advance.

### CROSS-REFERENCE TO RELATED APPLICATION

This application is a National Stage application under 35 U.S.C. § 371 of International Application No. PCT/KR2022/004243, filed on Mar. 25, 2022, which claims the benefit of Korean Patent Application No. 10-2021-0169888, filed on Dec. 1, 2021. The disclosures of the prior applications are incorporated by reference in their entirety

### TECHNICAL FIELD

The present disclosure relates to a method for predicting an operational error of a home appliance, and a server performing the same, and in particular, a method for accurately determining the location of a residential space in which a home appliance is installed, predicting an operational error of the home appliance, and providing guide information for preventing a predicted operational error of the home appliance to the user as well as informing the user of the predicted operational error of the home appliance, and a server performing the same.

### BACKGROUND ART

Home appliances are installed in the user's residential space, and perform a variety of functions. For example, home appliances may comprise a washing machine, a dryer, an air conditioner, an air purifier and the like.

In particular, the washing machine and the dryer are installed in an installation space directly exposed to an outdoor environment, such as a utility room, a veranda and the like of the user's residential space. The installation space separates from a living room, a bedroom, a kitchen and the like which are used for day-to-day activities. Ordinarily, the temperature in the installation space may differ from temperature of the spaces which are used for day-to-day activities.

Additionally, in the winter, the temperature in an outdoor space decreases, and the temperature in the installation space also decreases. A decrease in the temperature of the installation space may lead to freezing of water remaining in the washing machine and the dryer. The washing machine and the dryer do not operate due to the frozen water. That is, the water remaining in the washing machine and the dryer is frozen, and causes freezing and bursting of the washing machine and the dryer. In the case of freezing and bursting of the washing machine and the dryer, an error message in relation to freezing and bursting is output to the display units of the washing machine and the dryer, and the user checks whether the washing machine and the dryer are frozen and burst through the output error message.

As related art, KR Patent No. 10-0347940 (hereinafter, “prior art 1”) and KR Patent Publication No. 10-2019-0116189 (hereinafter, “prior art 2”) are published.

Prior art 1 suggests a method for controlling a remotely controllable washing machine. According to prior art 1, the method comprises receiving information such as weather, time, a season and the like, and based on the received information, diagnosing a failure of a washing machine and controlling a washing administration and the like.

However, according to prior art 1, a function of informing the user of a failure of a washing machine in the case where the washing machine fails is provided, but the failure of the washing machine is not prevented.

Prior art 2 suggests a device and method for predicting freezing of a washing machine. According to prior art 2, based on temperature data sensed by the sensor of a washing machine and atmospheric temperature data received from a meteorological office server, a relationship between a change in the temperature of the washing machine and the atmospheric temperature data is determined, and based on the relationship and an atmospheric temperature forecast received from the meteorological office server, freezing of the washing machine is predicted.

However, according to prior art 2, the atmospheric temperature data relate to a large administrative division (for example, Seoul special city and the like) comprising the user's residential space. Thus, according to prior art 2, atmospheric temperature data regarding a large administrative division comprising the user's residential space are obtained, but accurate atmospheric temperature data regarding a specific administrative division (for example, Gangnam-gu and the like) are not obtained. Thus, atmospheric temperature data on a specific administrative division regarding a residential space are not obtained, and freezing of a washing machine is not predictable accurately.

### DISCLOSURE

### Technical Problem

The objective of the present disclosure is to provide a method for predicting an operational error of a home appliance accurately and a server performing the same.

Further, the objective of the present disclosure is to provide a method for accurately recognizing the location information of the user's residential space in which a home appliance is installed and managing the home appliance, and a server performing the same.

Furthermore, the objective of the present disclosure is to provide a method for preventing a failure of a home appliance, such as freezing and bursting of a clothes processing device, overheating of an air conditioner, a replacement of the filter of an air purifier, and the like, and a server performing the same.

Aspects according to the present disclosure are not limited to the above ones, and other aspects and advantages that are not mentioned above can be clearly understood from the following description and can be more clearly understood from the embodiments set forth herein.

### Technical Solutions

In a method for predicting an operational error of a home appliance and a server performing the same of one embodiment, future weather information of a specific administrative division regarding a residential space may be obtained, and the obtained future weather information of a specific administrative division may be compared with past environmental information detected in a home appliance, and the server may predict an operational error of the home appliance in advance based on the comparison. So, an operational error of the home appliance, which may occur in the future, is predicted accurately.

Additionally, in the method for predicting an operational error of a home appliance and the server performing the same of one embodiment, information on a specific administrative division regarding a residential area, which is administrative information except for a top-level administrative division among administrative divisions regarding the residential space, may be obtained from a home appliance. Thus, accurate weather information of a specific administrative division regarding a residential space may be obtained.

Further, in the method for predicting an operational error of a home appliance and the server performing the same of one embodiment, a message for guiding management of a home appliance may be provided to the user, in the case where an operational error of a home appliance is predicted to occur. Thus, the operational error of the home appliance may be prevented.

Further, the server of one embodiment may comprise a memory configure to store one or more of instructions, and a processor configured to execute one or more of the instructions and to perform an operation of managing the home appliance. The processor may obtain a message for requesting a registration of the home appliance, comprising information on a specific administrative division regarding the residential space, and based on the message for requesting a registration, registers the home appliance, obtain environmental information detected by a sensor of the home appliance after the home appliance is registered, obtain weather information in a second time section of the specific administrative division, based on the information on a specific administrative division, and predict whether an operational error of the home appliance occurs in the second time section, based on the environmental information in a first time section prior to the second time section and the weather information in the second time section.

The method for predicting an operational error of a home appliance may comprise obtaining a message for requesting a registration of the home appliance comprising information on a specific administrative division regarding the residential space, registering the home appliance, based on the message for requesting a registration, obtaining environmental information detected by a sensor of the home appliance after the home appliance is registered, obtaining weather information in the second time section of the specific administrative division, based on the information on a specific administrative division, and predicting whether an operational error of the home appliance occurs in the second time section, based on the environmental information in a first time section prior to the second time section and the weather information in the second time section.

### Advantageous Effects

According to the present disclosure, an operational error of a home appliance, which may occur in the future, may be predicted accurately, thereby preventing failure of the home appliance and ensuring continuity of use of the home appliance.

According to the present disclosure, accurate current weather information of a specific administrative division may be obtained, thereby accurately predicting an operational error of a home appliance, which may occur in the future.

According to the present disclosure, a failure of a home appliance, such as freezing and bursting of a clothes processing device, overheating of an air conditioner, a replacement of the filter of an air purifier, and the like, may be prevented.

Specific effects are described along with the above-described effects in the section of detailed description.

### BRIEF DESCRIPTION OF DRAWINGS

FIG. 1 is a view showing a schematic configuration of a home appliance management system of one embodiment.

FIG. 2 is a block diagram showing a management server of one embodiment.

FIG. 3 is a view showing a schematic structure of a washing machine as one example of a home appliance of one embodiment.

FIG. 4 is a view showing a schematic structure of a dryer as an example of the home appliance of one embodiment.

FIG. 5 is a view showing a schematic structure of an air conditioner as an example of the home appliance of one embodiment.

FIG. 6 is a view showing the flow of a method for predicting an operational error of the home appliance of one embodiment.

FIG. 7 is a view for explaining a process of inputting information on a specific administrative division regarding a residential space, in a message for requesting a registration of one embodiment.

FIG. 8 is a view showing an example of a message for guiding management.

### DETAILED DESCRIPTION OF EXEMPLARY EMBODIMENTS

Since embodiments may be modified and changed in various different forms, specific embodiments are described with reference to accompanying drawings. However, it is to be understood that the specific embodiments are not intended to limit the subject matter of the present disclosure and that all modifications, equivalents or replacements within the technical spirit and scope of the present disclosure are included in the scope of the present disclosure. Further, in the drawings, similar reference numerals denote similar components.

The terms “first”, “second” and the like are used herein only to distinguish one component from another component. Throughout the disclosure, each component may be a single or a plurality of ones, unless state to the contrary.

In the disclosure, the term “comprise” or “include” and the like does not imply necessarily including stated components or stated steps and imply including additional components or additional step.

The terms used herein are simply to describe a specific embodiment and are not intended to limit the subject matter of the present disclosure. In the disclosure, singular forms include plural forms as well, unless explicitly indicated otherwise. In the disclosure, it is to be understood that the term “comprise” or “have” and the like implies the presence of necessarily including stated features, numbers, steps, operations, components, parts or combinations thereof and does not imply excluding the presence or addition of one or more of other features, numbers, steps, operations, components, parts or combinations thereof.

Hereinafter, embodiments according to the present disclosure are described with reference to the accompanying drawings.

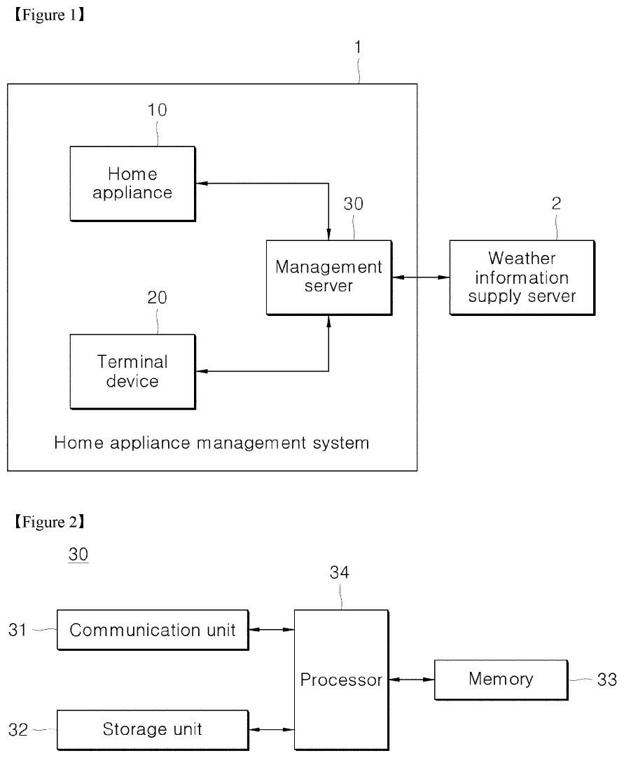

FIG. 1 is a view showing a schematic configuration of a home appliance management system 1 of one embodiment.

Referring to FIG. 1, the home appliance management system 1 may comprise a home appliance 10, a terminal device 20 and a management server 30. The home appliance management system 1 may receive weather information from a weather information supply server 2 that is an external server.

The home appliance 10 denotes an electronic product that is installed in the residential space of the user and performs a variety of functions.

In the embodiment, the home appliance 10 may comprise a washing machine doing the laundry, a dryer drying laundry, an air conditioner air-conditioning air in a residential space, an air purifier purifying air in a residential space, a clothes management device managing or refreshing clothes, and the like.

The home appliance 10 may comprise an operation performance unit, a communication unit, a control unit, a display unit and a sensor.

The operation performance unit of the home appliance 10 may be a component that performs a unique operation provided by a home appliance 10. In an example, the unique operation may be a washing operation of a washing machine, a drying operation of a dryer, an air-conditioning operation of an air conditioner, an air-purifying operation of an air purifier, and the like.

The communication unit of the home appliance 10 may communicate with the management server 30. To this end, the communication unit of the home appliance 10 may comprise a short-range communication module and/or a long-distance communication module.

The short range communication module may be a communication module based on Bluetooth, radio frequency identification (RFID), infrared data association (IrDA), ultra-wideband (UWB), ZigBee and wireless fidelity (WiFi). The long-distance communication module may be a communication module based on code division multiple access (CDMA), frequency division multiple access (FDMA), time division multiple access (TDMA), orthogonal frequency division multiple access (OFDMA) and single carrier frequency division multiple access (SCFDMA).

The control unit of the home appliance 10 may comprise a memory and a processor.

The memory of the home appliance 10 may be a volatile and/or non-volatile memory, and store one or more instructions or data in relation to at least one of other components of the home appliance 10.

The processor of the home appliance 10 may comprise one or more of a central processing unit (CPU), an application processor or a communication processor. The processor of the home appliance 10 may execute one or more stored instructions. Accordingly, the processor of the home appliance 10 may control the operation of the home appliance 10.

The display unit of the home appliance 10 may be comprised of a liquid crystal display (LCD), a light-emitting diode display (LED), an organic light-emitting diode display (OLED) and the like, and may be a device that can display an image or an image frame in relation to the driving of the home appliance 10 to the user.

The sensor of the home appliance 10 may be a device that detects environmental information in relation to the home appliance 10. The environmental information may comprise a temperature value in the home appliance 10, a humidity value, a fine dust concentration and the like. Information detected by the sensor of the home appliance 10 may be delivered to the processor.

The home appliance 10 is specifically described hereinafter.

The terminal device 20 may be a device possessed by the user, and for example, comprise a smartphone, a laptop, a table PC, a smart TV, a smart watch and the like.

The terminal device 20 may comprise a communication unit, a control unit and a display unit.

The communication unit of the terminal device 20 may communicate with the management server 30.

The control unit of the terminal device 20 may control the communication unit of the terminal device 20 and the display unit of the terminal device 20, and comprise a memory and a processor.

The memory of the terminal device 20 may store an application for a terminal, which is used for managing the home appliance 10. The processor of the terminal device 20 may execute the application for a terminal.

The display unit of the terminal device 20 may output an execution screen of the application for a terminal.

In addition, the communication unit, control unit and display unit of the terminal device 20 are similar to the above-described communication unit, control unit and display unit of the home appliance 10, and detailed description in relation to them is omitted.

The management server 30 may be a device that manages the home appliance 10 remotely.

FIG. 2 is a block diagram showing a management server 30 of one embodiment.

Referring to FIG. 2, the management server 30 may comprise a communication unit 31, a memory 33 and a processor 34.

The communication unit 31 may communicate with the home appliance 10, the terminal device 20 and the weather information supply server 2. The communication unit 31 may comprise a short range communication module and/or a long-distance communication module. The short range communication module and the long-distance communication module are described above.

Specifically, the communication unit 31 may receive environmental information of the home appliance 10, detected by the sensor of the home appliance 10, from the home appliance 10, and transmit a message for guiding management of the home appliance 10 to the home appliance 10.

Additionally, the communication unit 31 may receive a message for requesting a registration of the home appliance 10 from the terminal device 20, and transmit a message for guiding management of the home appliance 10 to the terminal device 20. At this time, the message for guiding management may be a message for preventing an operational error from occurring, in the case where the operational error of the home appliance 10 is predicted to occur.

Further, the communication unit 31 may transmit a message (i.e., a weather information request message) for requesting weather information of a specific administrative division comprising the residential space of the user, in which the home appliance 10 is installed, to the weather information supply server 2, and receive the weather information of a specific administrative division from the weather information supply server 2. At this time, the weather information of a specific administrative division may be current weather information or future weather information (i.e., weather information of days after tomorrow) on a specific administrative division.

In the present disclosure, an administrative division may be divided depending on levels. As for South Korea, an administrative division may be divided into three levels. A first level (i.e., an top-level) may be a province/a special city/a metropolitan city, a second level (i.e., a middle level) may be a city/a GUN/a GU, and a third level (i.e., a bottom-level) may be an EUP/a MYEON/a DONG. Accordingly, the specific administrative divisions described above may correspond to the administrative divisions, i.e., the middle administrative division or the bottom-level administrative division, except for the top-level administrative division, among the administrative divisions.

The storage unit 32 may store information in relation to the home appliance 10.

At this time, the information in relation to the home appliance 10 may be received from the terminal device 20 and the home appliance 10. The information in relation to the home appliance 10 may comprise a serial number of the home appliance 10 and information on a specific administrative division regarding a residential space that are received from the terminal device 20. The information in relation to the home appliance 10 may further comprise environmental information received from the home appliance 10. The environmental information may be detected by the sensor included in the home appliance 10.

The memory 33 may be a volatile and/or non-volatile memory, and store one or more instructions or data in relation to the management of the home appliance 10. In particular, the memory 33 may store an application for a server, which is used for managing the home appliance 10.

The processor 34 may comprise one or more of a central processing unit (CPU), an application processor or a communication processor. The processor 34 may execute one or more instructions stored in the memory 33. In particular, the processor 34 may execute the application for a server. Accordingly, the processor 34 may manage the home appliance 10.

The weather information supply server 2 may generate weather information in each predetermined cycle. The weather information may be generated for each administrative division, and may comprise temperature information, humidity information, fine dust concentration information and the like.

The weather information supply server 2 may generate weather information in relation to the first level or weather information in relation to the second level or weather information in relation to the third level.

Hereinafter, an example of the home appliance 10, managed by the management server 30, is described briefly.

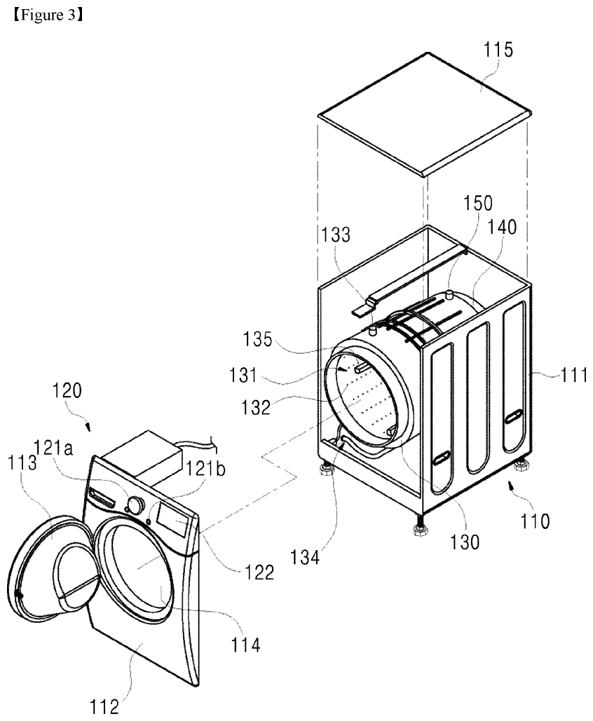

FIG. 3 is a view showing a schematic structure of a washing machine as one example of a home appliance 10 of one embodiment.

Referring to FIG. 3, the washing machine may comprise a cabinet 110, a tub 130, a drum 131, a driving unit 140 and a UI 120.

The cabinet 110 forms the exterior of the washing machine. The cabinet 110 may comprise a main body 111, a cover 112 provided on the front surface of the main body 111 and coupled to the front surface of the main body 111, and a top plate 115 coupled to the upper portion of the main body 111. The cover 112 may comprise an open portion 114 provided in such a way that laundry comes in and out, and a door 113 configured to open and close the open portion 114 selectively.

The tub 130 is provided in the cabinet 110 and supported by the cabinet 110.

The drum 131 is rotatably provided in the tub 130, and laundry is inserted into the drum 131. The drum 131 may form a space in which the laundry inserted into the drum 131 is washed, and be supplied with power from the driving unit 140 to rotate. As the drum 131 rotates, the contaminants of the laundry inserted into the drum 131 may be removed during friction between the laundry and wash water stored in the tub 130. Additionally, the drum 131 may further comprise a lifter 135 for stirring the laundry.

The drum 131 is provided with a plurality of through holes 132, such that the wash water stored in the tub 130 may flow into the drum 132 through the through holes 132, and the wash water in the drum 131 may be discharged to the tub 130.

The driving unit 140 may comprise a motor, and supply torque to the drum 131 to rotate the drum. The driving unit 140 may be controlled by the control unit of the home appliance 10.

The UI 120 is a component that allows the user to check information on doing the laundry as well as allowing the user to input information on doing the laundry. The UI 120 may comprise an input interface 121 to which a control instruction of the user is input, and an output interface 122 which displays control information based on the control instruction. The output interface 122 may correspond to the display unit.

Additionally, the washing machine may further comprise a water supply hose (not illustrated), a water supply part 133, a water discharge part 134, a dispenser (not illustrated), a water supply pipe (not illustrated), a water supply valve (not illustrated) and a pump (not illustrated).

The water supply hose guides water supplied from an external water source to the tub 130. The water supply part 133 regulates at least one water supply hose. The dispenser supplies an additive such as detergent, fabric softener and the like into the drum 131. The water supply pipe guides water supplied through the water supply part 133 to the dispenser. The water supply valve regulates the water supply pipe. The water discharge part 134 may comprise a water discharge opening through which water is discharged from the tub 130, and a pump which pumps discharged water.

Further, the washing machine may further comprise a sensing part 150 and a sensor (not illustrated).

The sensing part 150 senses various types of information. In an example, the sensing part 150 may sense information such as a driving current of the motor, a rotation speed of the drum, a chemical substance remaining in wash water and the like.

A temperature sensor detects a temperature value in the washing machine, for example, a temperature value of water remaining in the washing machine. The temperature sensor may be a thermistor. The temperature sensor may be installed in the lower portion of the tub 130, or installed near the hose.

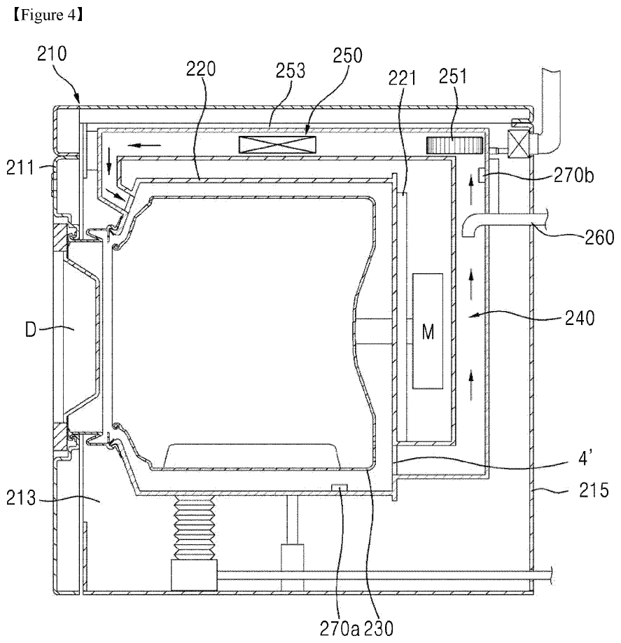

FIG. 4 is a view showing a schematic structure of a dryer as an example of the home appliance 10 of one embodiment.

Referring to FIG. 4, the dryer comprises a cabinet 210 forming the exterior of the dryer, a tub 220 provided inside the cabinet 210 and configured to reserve wash water, a drum 230 installed inside the tub 220 in such a way that the drum is swiveled by a motor M, a condensing duct 240 configured to condense air in the drum 120, a drying duct 250 configured to heat air condensed by the condensing duct 240, a cooling water supply part 260 configured to supply cooling water to the condensing duct 240, and a cooling fan 251 provided in the cabinet 210.

The cabinet 210 comprises a front panel 211 provided with a door D, a side panel 213 connected to both sides of the front panel 211, and a rear panel 215 coupled to the end of the side panel 213. The cabinet 210 may be provided with an inlet (not illustrated) configured to draw external air, and an outlet (not illustrated) configured to discharge air in the cabinet 210, and the inlet and the outlet may be formed in such a way that the inlet and the outlet penetrate the cabinet 210.

The cooling water supply part 260 is installed at the condensing duct 240. The cooling water supply part 260 supplies cooling water such that moisture in air passing through the condensing duct 240 may be condensed. That is, at a time of drying, moisture-containing air discharged from the drum 230 moves to the condensing duct 240 through the tub 220, and while passing through the condensing duct 240, meets with the cooling water supplied by the cooling water supply part 260, such that the moisture is condensed. The condensed moisture falls down to the lower end of the condensing duct 240 and flows again into the tub 220 and then is discharged.

One side of the condensing duct 240 connects to the rear surface of the tub 220, and the other side connects to the drying duct 250. Dry air is heated in the drying duct 250, through a drying heater 253. The drying duct 250 supplies heated air into the drum 230. The drying duct 250 has an air blowing fan 251 therein, and the air blowing fan 251 draws air in the condensing duct 240 into the drying duct 250 and blows the air into the tub 220 or the drum 230.

Additionally, the dryer may further comprise a temperature sensor 270a, 270b. The temperature sensor 270a, 270b may detect a temperature value in the dryer. The detected temperature value may be used for a drying operation of the dryer.

A first temperature sensor 270a may detect a temperature value of circulating air before it is drawn into the condensing duct 240. The first temperature sensor 270a may be installed near an inlet 241 of the condensing duct 240. The first temperature sensor 270a indirectly detects an atmosphere temperature value of circulating air the heat of which is exchanged in the drum 230 after the supply of hot air.

A second temperature sensor 270b may be installed in the condensing duct 240. Certainly, the second temperature sensor 270b may also be installed in the drying duct 250. The second temperature sensor 270b detects a temperature value of air circulating in the condensing duct 240 or the drying duct 250. The second temperature sensor 270b detects a temperature value of circulating air after it passes through a condensing/condensed water supply part 260.

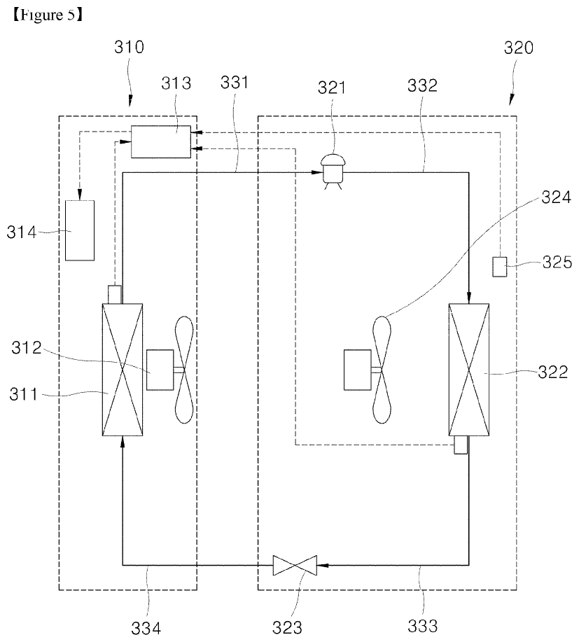

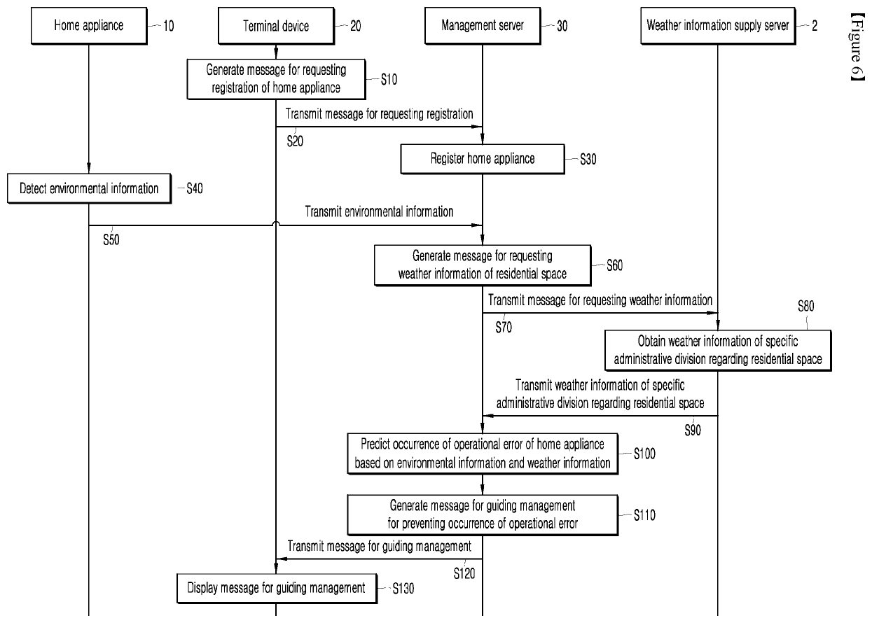

FIG. 5 is a view showing a schematic structure of an air conditioner as an example of the home appliance 10 of one embodiment.

Referring to FIG. 5, the air conditioner comprises an indoor unit 310 and an outdoor unit 320.

The indoor unit 310 comprises an evaporator 311, an indoor air blowing fan 312, a control unit 313 and a display unit 314. The outdoor unit 320 comprises a compressor 321, a condenser 322, an expander 323, an outdoor air blowing fan 324 and a temperature sensor 325. Refrigerants move to a refrigerant pipe 331, 332, 333, 334.

The compressor 321 compresses a gaseous refrigerant at high-temperature and high-pressure. The condenser 322 condenses the compressed high-temperature high-pressure gaseous refrigerant by using air. The expander 323 expands the condensed refrigerant. The evaporator 311 evaporates the expanded refrigerant. The indoor air blowing fan 312 draws indoor air into the indoor unit 310 and then discharges the indoor air to an indoor space again. The outdoor air blowing fan 324 draws outdoor air into the outdoor unit 320 and then discharges the outdoor air to an outdoor space again.

The temperature sensor 325 detects a temperature value in the outdoor unit 320. The detected temperature value is delivered to the control unit 313. The display unit 314 may display the detected temperature value, based on a signal output from the control unit 313.

Hereinafter, an example of management of the home appliance 10 by the management server 30 is specifically described based on the above details.

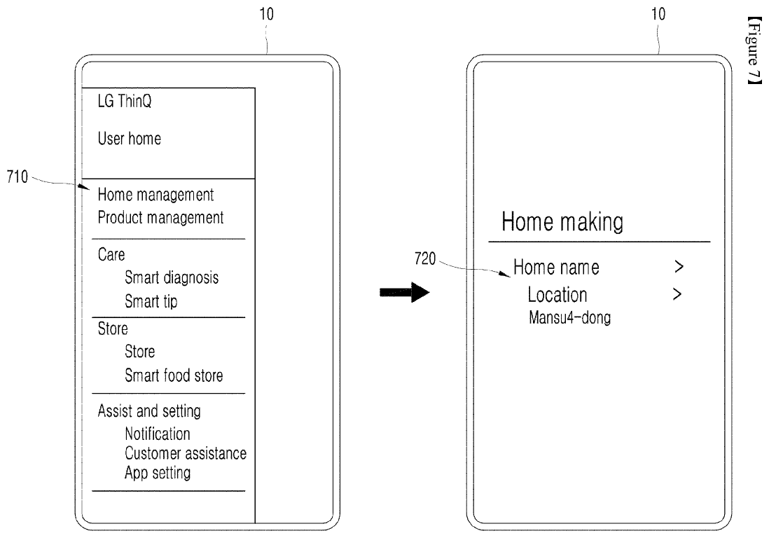

FIG. 6 is a view showing the flow of a method for predicting an operational error of the home appliance 10 of one embodiment.

Herein, the method for managing the home appliance 10 may be performed by a plurality of home appliances 10 of the user, and for convenience of description, FIG. 6 shows a method for managing one home appliance 10.

Additionally, the method for managing the home appliance 10 may involve predicting whether an operational error of the home appliance 10 occurs, and in the case where the occurrence of an operational error of the home appliance 10 is predicted, preventing the occurrence of an operational error of the home appliance 10. At this time, steps that are performed by the management server 30 may constitute a method for controlling the management server 30.

Further, assume that the application for a terminal is executed in the terminal device 20, and that the application for a server is executed in the server 30.

Hereinafter, steps in each process are described specifically.

In step 10 (S10), the terminal device 20 may generate a message for requesting a registration of the home appliance 10.

Specifically, in the case where the home appliance 10 is installed in the residential space of the user, the user may register the home appliance 10 with the management server 30 through the terminal device 20. For the home appliance 10 to be registered, the terminal device 20 may generate a message for requesting a registration of the home appliance 10.

The message for requesting a registration may comprise a serial number of the home appliance 10, and further comprise information on a specific administrative division regarding a residential space in which the home appliance 10 is installed.

As described above, an administrative division may be divided depending on levels. As for South Korea, the administrative division may be divided into three levels. A first level (i.e., an top-level) may be a province/a special city/a metropolitan city, a second level (i.e., a middle level) may be a city/a GUN/a GU, and a third level (i.e., a bottom-level) may be an EUP/a MYEON/a DONG.

The information on a specific administrative division may correspond to the administrative divisions, except for the top-level administrative division, among the administrative divisions. In an example, as for South Korea, the information on a specific administrative division may be location information on a city/a GUN/a GU or an EUP/a MYEON/a DONG.

FIG. 7 is a view for explaining a process of inputting information on a specific administrative division regarding a residential space, in a message for requesting a registration of one embodiment.

Referring to FIG. 7, an application for a terminal may be executed in the terminal device 20. In the case where the user selects a home management menu 710 on the screen of a “user home”, the screen of “home making” may be displayed.

The user may select a location menu 720 to set a “home name” to directly input information on a specific administrative division regarding a residential space.

Alternatively, the terminal device 20 may comprise a GPS module. The GPS module may sense the location information of the terminal device 20. The location information sensed by the GPS module may link with the application for a terminal. Accordingly, the location information sensed by the GPS module may be automatically input to the location menu 720 on the screen of “home making”. That is, the information on a specific administrative division regarding a residential space may be automatically input to the location menu 720. The information on a specific administrative division regarding a residential space, directly input or automatically input, may be information (i.e., information on a “DONG”) on the bottom-level administrative division regarding a residential space.

In short, the home appliance 10 may be provided with a location measurement device (i.e., a GPS module) measuring location information of the home appliance 10. The location information of the home appliance 10 may correspond to information on a specific administrative division regarding a residential space, and the information on a specific administrative division may be input to the application for a terminal automatically.

Referring back to FIG. 6, the home appliance 10 in step 20 (S20) may transmit a message for requesting the generated message for requesting a registration to the management server 30.

In step 30 (S30), the management server 30 may register the home appliance 10, based on the received message for requesting a registration.

That is, the management server 30 may register the home appliance 10, based on a serial number of the home appliance 10 and the information on a specific administrative division regarding a residential space. At this time, the serial number of the home appliance 10 and the information on a specific administrative division regarding a residential space may match each other and be stored in the storage unit 32 of the management server 30.

Step 40 (S40) and step 50 (S50) may be performed after the home appliance 10 is registered.

In step 40 (S40), the home appliance 10 may detect environmental information. Additionally, in step 50 (S50), the home appliance 10 may transmit the environmental information detected to the management server 30.

The environmental information may be environmental information in relation to the home appliance 10, and comprise at least one of temperature information, humidity information and fine dust concentration information. The environmental information may be detected by a sensor installed in the home appliance 10.

Additionally, the home appliance 10 may continue to detect environmental information in each predetermined cycle and transmit the environmental information to the management server 30. That is, step 40 (S40) and step 50 (S50) may be performed periodically.

In the embodiment, the home appliance 10 may correspond to a clothes processing device such as a washing machine (see FIG. 3), a dryer (see FIG. 4) and the like. At this time, the environmental information may correspond to a temperature value in the clothes processing device, and the sensor may correspond to a temperature sensor detecting a temperature value in the clothes processing device.

In particular, in the case where the clothes processing device is a washing machine, a temperature value in the clothes processing device may correspond to a temperature value of water remaining in the washing machine. Further, in the case where the clothes processing device is a dryer, a temperature value in the clothes processing device may correspond to a temperature value of a duct included in the dryer. Particulars in relation to this are provided in FIGS. 3 and 4.

In another embodiment, the home appliance 10 may correspond to an air conditioner (see FIG. 5). At this time, the environmental information may correspond to a temperature value in the outdoor unit of the air conditioner, and the sensor may correspond to a temperature sensor detecting a temperature value in the outdoor unit of the air conditioner.

In yet another embodiment, the home appliance 10 may correspond to an air purifier. At this time, the environmental information may correspond to a fine dust concentration in the air purifier, and the sensor may correspond to a fine dust sensor measuring a fine dust concentration in the air purifier.

Referring back to FIG. 6, the management server 30 in step 60 (S60) may generate a message for requesting weather information of a residential space, based on information on a specific administrative division regarding a residential space. That is, the management server 30 may generate a message for requesting weather information in relation to a specific administrative division regarding a residential space, based on the information on a specific administrative division regarding a residential space that is stored in the storage unit 32.

In step 70 (S70), the management server 30 may transmit the message for requesting weather information to the weather information supply server 2.

In step 80 (S80), the weather information supply server 2 may obtain weather information of a specific administrative division regarding a residential space, based on the message for requesting weather information. The weather information may be weather information in a second time section. The second time section may be a time section after a current date or a time section of a current date.

In step 90 (S90), the weather information supply server 2 may transmit the obtained weather information of a specific administrative division regarding a residential space to the management server 30.

Herein, step 60 (S60) to step 90 (S90) may be performed periodically.

Further, after step 40 (S40) and step 50 (S50), step 60 (S60) to step 90 (S90) are performed in FIG. 6, but not limited. Step 40 (S40) and step 50 (S50) may be performed apart from step 60 (S60) to step 90 (S90). That is, step 40 (S40) and step 50 (S50) may be performed at the same time as step 60 (S60) to step 90 (S90) are performed, or step 40 (S40) and step 50 (S50) may be performed after step 60 (S60) to step 90 (S90).

In step 100 (S100), the management server 30 may predict an operational error of the home appliance 10, based on environmental information of the home appliance 10 and weather information of a specific administrative division regarding a residential space.

Herein, the environmental information of the home appliance 10 may be environmental information detected in a first time section that is a time section before a current date. In an example, the first time section may correspond to a time section of past two weeks of a current date. Additionally, the weather information of a specific administrative division regarding a residential space may be outdoor weather information of a specific administrative division in a second time section that is a time section after a current date.

Alternatively, the environmental information of the home appliance 10 and the weather information of a specific administrative division regarding a residential space may be environmental information and weather information of a current date. That is, the first time section and the second time section may be included in a current date.

Additionally, the management server 30 may predict whether an operational error of the home appliance 10 occurs in the second time section.

That is, in step 100 (S100), the management server 30 may predict whether an operational error of the home appliance 10 occurs in the second time section, based on the environmental information in the first time section and the weather information of a specific administrative division in the second time section. At this time, the environmental information in the first time section may be obtained based on environmental information that is stored in the storage unit 32 periodically.

In the embodiment, in the case where the home appliance 10 is a clothes processing device, a representative temperature value in the clothes processing device, in the first time section, is less than a first predetermined critical temperature value, and a temperature value of a specific administrative division regarding a residential space in the second time section is less than a second predetermined critical temperature value, the management server 30 may predict that a first operational error occurs in the second time section.

Herein, the representative temperature value in the clothes processing device may correspond to a minimum temperature value in the cloths processing device in the first time section. In an example, the minimum temperature value in the clothes processing device may correspond to a minimum temperature value of the clothes processing device for two weeks. Further, the first operational error may be an operational error in relation to freezing and bursting of the clothes processing device.

Further, in the case where the clothes processing device is a washing machine and a dryer, the first critical temperature value may be −10° C., and the second critical temperature value may be −3° C. That is, the management server 30 may predict that the first operational error of the washing machine will occur at a time point following a current time point, in the case where a minimum temperature value in the washing machine, in the first time section, is less than −10° C. that is the first critical temperature value, and a temperature value of a specific administrative division regarding a residential space is less than −3° C. that is the second critical temperature value.

At this time, the first operational error in relation to the washing machine may comprise a water supply error (i.e., a water inlet error) and a water discharge error (i.e., a water outlet error) of a washing machine, and a freeze failure (ff) of the water supply part and the water discharge part. Further, the first operational error in relation to the dryer may comprise a water discharge error and a water empty error of a washing machine.

In another embodiment, in the case where the home appliance 10 is an air conditioner, a representative temperature value in the outdoor unit of the air conditioner, in the first time section, is greater than a third predetermined critical temperature value, and a temperature value of a specific administrative division regarding a residential space, at a current time point, is less than a fourth predetermined critical temperature value, the management server 30 may predict that the second operational error will occur in the second time section.

Herein, the representative temperature value in the outdoor unit may correspond to a maximum temperature value in the outdoor unit in the first time section. In an example, the maximum temperature value in the outdoor unit may correspond to a maximum temperature value of the clothes processing device for two weeks.

In an example, the third critical temperature value may be 40° C., and the fourth critical temperature value may be 35° C. That is, in the case where a maximum temperature value in a washing machine in the first time section is greater than 40° C. that is the third critical temperature value, and a temperature value of a specific administrative division regarding a residential space is greater than 35° C. that is the fourth critical temperature value, the management server 30 may predict that the second operational error of the washing machine will occur at a time point following a current time point. The second operational error may be an operational error in relation to damage to the outdoor unit caused by overheating.

In yet another embodiment, in the case where the home appliance 10 is an air purifier, the management server 30 may predict that a third operational error will occur in the second time section, based on a fine dust concentration detected in the air purifier in the first time section and a fine dust concentration of a specific administrative space of a residential space in the second time section. The third operational error may be an operational error in relation to replacement of a filter installed in the air purifier. Additionally, the first time section and the second time section, as described above, may be included in a current date.

In an example, in the case where a fine dust concentration in the air purifier is greater than an outdoor fine dust concentration of a specific administrative space of a residential space, fine dust may continue to be piled in the filter of the air purifier, the third operational error in which a filter is replaced may be predicted. That is, the third operational error may correspond to a situation where a time point when a filter is replaced is brought forward.

Then the management server 30, in step 110 (S110), may generate a message for guiding management for preventing the occurrence of an operational error in the case where the occurrence of an operational error of the home appliance 10 is predicted.

In step 120 (S120), the management server 30 may transmit the massage for guiding management to the terminal device 210.

In step 130 (S130), the terminal device 20 may display the message for guiding management on the display unit.

Further, in FIG. 6, the message for guiding management is displayed on the terminal device 20, but the message for guiding management may be displayed on the display unit after being transmitted to the home appliance 10.

In the embodiment, the message for guiding management may comprise first management guide information corresponding to a cause for the occurrence of an operational error and second management guide information regarding a method for preventing the occurrence of an operational error.

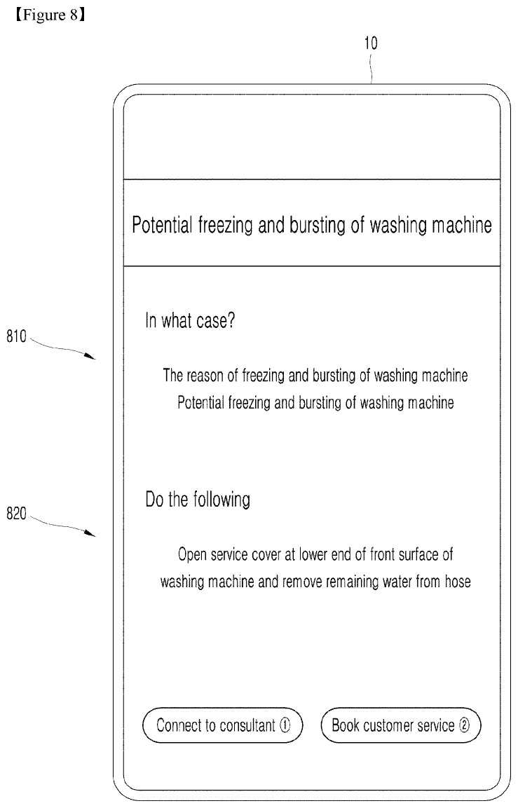

FIG. 8 is a view showing an example of a message for guiding management.

Referring to FIG. 8, the home appliance 10 may correspond to a washing machine. Additionally, the first management guide information 810 may comprise description of a cause for the occurrence of the washing machine's freezing and bursting, and the second management guide information 820 may comprise description of a method for preventing the occurrence of the washing machine's freezing and bursting.

In another example, in the case where the home appliance 10 is an air conditioner, the first management guide information may comprise description of a cause for damage to the outdoor unit resulting from overheating, and the second management guide information may comprise a method for preventing the occurrence of damage to the outdoor unit caused by overheating.

In yet another example, in the case where the home appliance 10 is an air purifier, the first management guide information may comprise description of a cause for replacement of a filter, and the second management guide information may comprise a method for determining a time point when windows in a residential space are opened. That is, in the case where a fine dust concentration detected in the air purifier is greater than an outdoor fine dust concentration of a specific administrative space of a residential space, the second management guide information may comprise information on a time point when windows are opened.

In summary, in the method for predicting an operational error of the home appliance 10 and the management server 30 performing the same of one embodiment, future weather information of a specific administrative division regarding a residential space may be obtained, and the future weather information obtained of a specific administrative division and past environmental information detected in the home appliance 10 may be compared to predict an operational error of the home appliance 10 in advance. Accordingly, an operational error of the home appliance 10, which would occur in the future, may be predicted accurately. As a result, a failure of the home appliance 10 may be prevented, and continuity of use of the home appliance 10 may be ensured.

In particular, in the method for predicting an operational error of the home appliance 10 and the management server 30 performing the same of one embodiment, information on a specific administrative division regarding a residential space, which is administrative information except for information on the top-level administrative division, among administrative divisions of a residential space may be obtained from the home appliance 10. Accordingly, accurate weather information of a specific administrative division regarding a residential space may be obtained.

Further, in the method for predicting an operational error of the home appliance 10 and the management server 30 performing the same of one embodiment, a failure of the home appliance such as the freezing ad bursting of a clothes processing device, the overheating of an air conditioner, the replacement of the filter of an air purifier and the like may be prevented in advance.

The embodiments in the present disclosure may be embodied in the form of program instructions to be executed through a variety of computer devices so as to be recorded on a computer-readable recording medium. The computer-readable recording medium may independently comprise program instructions, data files, data structures and the like or may comprise a combination thereof. The program instructions recorded on the medium may be specially designed and configured for the subject matter of the present disclosure or may be well-known to and used by those skilled in the art relating to computer software program. Examples of the computer-readable recording media include magnetic media such as hard disks, floppy disks and magnetic tape, optical media such as CD-ROMs and DVDs, magneto-optical media such as floptical disks, and hardware devices that are specially configured to store and perform program instructions such as Read Only Memory (ROM), Random Access Memory (RAM), flash memory etc. Examples of the program instructions include a high-level language code executed by the computer through an interpreter as well as a machine language code produced by a compiler. The hardware devices may be configured to operate as one or more of software modules for performing the operation of the embodiments in the disclosure, and vice versa.

The subject matter of the present disclosure is described with reference to particulars such as the components and the like, the limited embodiments and the limited drawings, but they are provided for a comprehensive understanding of the subject matter in the disclosure. Embodiments are not limited to the embodiments set forth herein, and one having ordinary skill in the art to which the disclosure pertains can understand that various modifications and changes are drawn from the particulars, embodiments and drawings. Thus, the technical scope of the present disclosure is not to be limitedly defined by the embodiment described herein, and the claims, and the equivalents and modifications thereof are to be included in the technical scope of the present disclosure.

1. A server managing a home appliance installed in a user's residential space, comprising:
a memory configure to store one or more of instructions; and
a processor configured to execute one or more of the instructions and to perform an operation of managing the home appliance,
wherein the processor obtains a message for requesting a registration of the home appliance, comprising information on a specific administrative division regarding the residential space, and based on the message for requesting a registration, registers the home appliance,
the processor obtains environmental information detected by a sensor of the home appliance after the home appliance is registered,
the processor obtains weather information in a second time section of the specific administrative division, based on the information on a specific administrative division, and
the processor predicts whether an operational error of the home appliance occurs in the second time section, based on the environmental information in a first time section prior to the second time section and the weather information in the second time section.

2. The server of claim 1, wherein the specific administrative division is an administrative division except for an top-level administrative division, out of administrative divisions of the residential space.

3. The server of claim 1, further comprising:
a communication unit configured to receive the message for requesting a registration from a terminal device of the user, to receive the environmental information from the home appliance and to receive current weather information of the specific administrative division from a weather information supply server; and
a storage unit configured to store the information on a specific administrative division and the environmental information,
wherein the processor obtains the environmental information in the first time section and the information on a specific administrative division from the storage unit.

4. The server of claim 3, wherein the processor executes an application for a server for managing the home appliance,
the terminal device executes an application for a terminal for managing the home appliance, and
the communication unit receives the message for requesting a registration from the terminal device through the application for a terminal.

5. The server of claim 4, wherein the home appliance is provided with a location measurement device configured to measure location information of the home appliance,
the location information of the home appliance corresponds to the information on a specific administrative division, and
the information on a specific administrative division is automatically input to the application for a terminal.

6. The server of claim 3, wherein the processor generates a message for requesting weather information, which requests the weather information in the second time section, based on the information on a specific administrative division,
the communication unit transmits the message for requesting weather information to the weather information supply server, and
the communication unit receives the weather information in the second time section from the weather information supply server.

7. The server of claim 1, wherein the first time section is a past time section, and the second time section is a future time section.

8. The server of claim 7, wherein the home appliance corresponds to a clothes processing device,
the environmental information corresponds to a temperature value in the clothes processing device,
the sensor corresponds to a temperature sensor,
the weather information in the second time section corresponds to a temperature value in the second time section, and
the operational error corresponds to a first operational error in relation to freezing and bursting of the clothes processing device.

9. The server of claim 8, wherein the processor predicts that the first operational error will occur in the second time section, in a case where a representative temperature value in the clothes processing device in the first time section is less than a first predetermined critical temperature vale, and a temperature value in the second time section is less than a second predetermined critical temperature value.

10. The server of claim 9, wherein the representative temperature value in the clothes processing device corresponds to a minimum temperature value in the clothes processing device in the first time section.

11. The server of claim 8, wherein the clothes processing device corresponds to a washing machine,
a temperature value in the clothes processing device corresponds to a temperature value of water remaining in the washing machine,
the temperature sensor detects a temperature value of the remaining water, and
the first operational error comprises a water supply error, a water discharge error and a freezing error of a water supply part or a water discharge part.

12. The server of claim 8, wherein the clothes processing device corresponds to a dryer,
a temperature value in the clothes processing device corresponds to a temperature value of a duct included in the dryer,
the temperature sensor detects a temperature value of the duct, and
the first operational error comprises a water discharge error and a water empty error.

13. The server of claim 7, wherein the home appliance corresponds to an air conditioner,
the environmental information corresponds to a temperature value in an outdoor unit of the air conditioner,
the sensor corresponds to a temperature sensor configured to detect a temperature value in the outdoor unit,
the weather information in the second time section corresponds to a temperature value in the second time section, and
the operational error corresponds to a second operational error in relation to damage to the outdoor unit caused by overheating.

14. The server of claim 1, wherein the home appliance corresponds to an air purifier,
the first time section and the second time section are included in the same date,
the environmental information corresponds to a fine dust concentration in the air purifier,
the sensor corresponds to a fine dust sensor configured to detect a fine dust concentration in the air conditioner,
the weather information in the second time section corresponds to a fine dust concentration in the second time section, and
the operational error corresponds to a third operational error in relation to a replacement of a filter of the air purifier.

15. The server of claim 1, wherein the processor generates a message for guiding management, which prevents the operational error from occurring in a case where the operational error is predicted to occur, and
the message for guiding management is provided to the terminal device of the user or the home appliance.

16. The server of claim 15, wherein the message for guiding management comprises first management guide information corresponding to a cause for occurrence of the operational error and second management guide information regarding a method for preventing the operational error from occurring.

17. A method for controlling a server, which involves predicting an operational error of a home appliance installed in a user's residential space, comprising:
obtaining a message for requesting a registration of the home appliance comprising information on a specific administrative division regarding the residential space and registering the home appliance, based on the message for requesting a registration;
obtaining environmental information detected by a sensor of the home appliance after the home appliance is registered;
obtaining weather information in the second time section based on the information on a specific administrative division; and
predicting whether an operational error of the home appliance occurs in the second time section, based on the environmental information in a first time section prior to the second time section and the weather information in the second time section.

18. The method of claim 17, wherein the first time section is a past time section, and the second time section is a future time section;
wherein the home appliance corresponds to a clothes processing device,
the environmental information corresponds to a temperature value in the clothes processing device,
the sensor corresponds to a temperature sensor,
the weather information in the second time section corresponds to a temperature value in the second time section, and
the operational error corresponds to a first operational error in relation to freezing and bursting of the clothes processing device.

19. The method of claim 18, wherein the clothes processing device corresponds to a washing machine,
a temperature value in the clothes processing device corresponds to a temperature value of water remaining in the washing machine,
the temperature sensor detects a temperature value of the remaining water, and
the first operational error comprises a water supply error, a water discharge error and a freezing error of a water supply part or a water discharge part.

20. The method of claim 18, wherein the clothes processing device corresponds to a dryer,
a temperature value in the clothes processing device corresponds to a temperature value of a duct included in the dryer,
the temperature sensor detects a temperature value of the duct, and
the first operational error comprises a water discharge error and a water empty error.
